(19) United States
(12) Patent Application Publication
(10) Pub. No.: US 2011/0154445 A1
(43) Pub. Date: Jun. 23, 2011

(54) SYSTEMS TO PROVIDE BUSINESS INFORMATION OVER SOCIAL NETWORKS

(76) Inventors: Markus Schmidt-Karaca, Heidelberg (DE); Peter Eberlein, Malsch (DE)

(21) Appl. No.: 12/644,835

(22) Filed: Dec. 22, 2009

(51) Int. Cl. G06F 21/20; G06Q 99/00; G06F 15/16

(52) U.S. Cl. 726/4; 705/319; 709/203

(57) ABSTRACT

Some aspects include registering a business application as a first user of an electronic social network comprising a plurality of users, data associated with each of the plurality of users, and associations between users representing data sharing relationships between associated users. Information to be shared with users of the electronic social network who are associated with the first user is determined, and the information is transmitted to the electronic social network for association with the first user. In some aspects, a request is received from the electronic social network to associate a second user of the electronic social network with the first user of the electronic social network, a correspondence between the second user of the electronic social network and a user of the business application is determined, it is determined whether the user of the business application is authorized to access the information to be shared with users of the electronic social network who are associated with the first user, and if it is determined that the user of the business application is authorized to access the information, the request is accepted from the electronic social network.

### BACKGROUND

Modern businesses rely on computer systems for storing, processing and presenting business data. These computer systems may provide several business applications, each of which is suited to a particular task. For example, a business may operate a Customer Relationship Management (CRM) application to support sales agents throughout all stages of customer interactions, a Human Resource Management (HRM) application to manage employee information and related processes, and a Supply Chain Management (SCM) application to monitor and control manufacturing, inventory, distribution, etc.

Business users access these business applications through proprietary client applications and/or portals provided by the business systems. A business user may be required to log in to several different applications/portals to consume desired business information. The business user may also log in to other personal or non-business systems to access other information of interest to the user.

Accordingly, systems are desired to facilitate consumption and/or distribution of business information generated by business applications. Such systems may reduce the number of applications which a user must operate in order to consume desired information.

### BRIEF DESCRIPTION OF THE DRAWINGS

FIG. 1 is a block diagram of a system according to some embodiments.

FIG. 2 is a flow diagram of a process according to some embodiments.

FIG. 3 is a view of a user interface according to some embodiments.

FIG. 4 is a flow diagram of a process according to some embodiments.

FIG. 5 is a view of a user interface according to some embodiments.

FIG. 6 is a view of a user interface according to some embodiments.

FIG. 7 is a flow diagram of a process according to some embodiments.

FIG. 8 is a flow diagram of a process according to some embodiments.

FIG. 9 is a view of a user interface according to some embodiments.

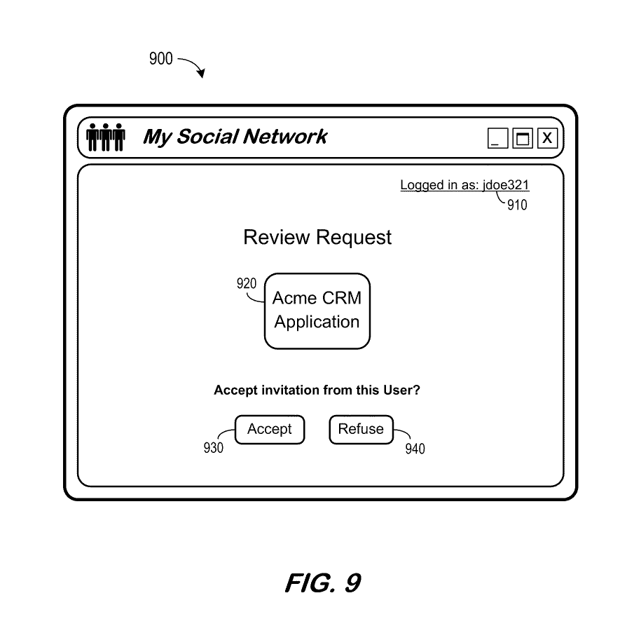

### DETAILED DESCRIPTION

The following description is provided to enable any person in the art to make and use the described embodiments and sets forth the best mode contemplated for carrying out some embodiments. Various modifications, however, will remain readily apparent to those in the art.

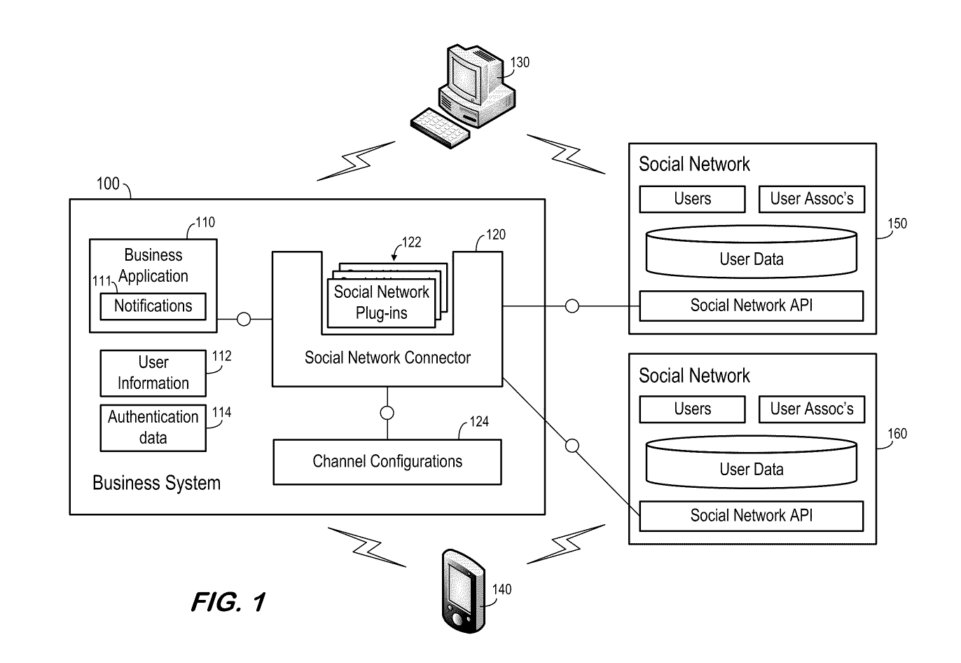

Some embodiments may be implemented using a hardware architecture such as that shown in FIG. 1. FIG. 1 includes business system 100, client devices 130 and 140, and electronic social networks 150 and 160. According to some embodiments, business system 100 transmits business information to electronic social networks 150 and 160, and client devices 130 and 140 are able to access the business information therefrom. Specific details of this operation according to some embodiments are provided below.

Business system 100 provides an environment to support execution of one or more business applications such as business application 110. As such, business system 100 provides common services for use by the one or more business applications, such as user authentication, data storage and retrieval, lifecycle management, etc. Business system 100 may comprise an application platform such as, but not limited to, SAP Netweaver.

User information 112 may include information associated with users of business system 100. User information 112 may include names, contact information, and organizational information, but is not limited thereto. According to some embodiments, user information 112 associates a business user with user names of one or more electronic social networks. Authentication data 114 is used during logon procedures to authenticate users of business system 100. Authentication data 114 may include certificates, passwords, or the like.

Business application 110 of business system 100 may comprise any software application which operates on any business information that is or becomes known, including those mentioned in the above Background. Business application 110 may provide notifications 111. Each of notifications 111 specifies conditions, one or more subscribers, and a message. During execution, business application 110 determines if the conditions of a notification 111 are satisfied and, if so, transmits the message of the notification 111 to the one or more subscribers of the notification 111.

Social network connector 120 comprises software to provide communication between business application 110 and social networks 150 and 160. Social network connector 120 may provide an application programming interface (API) usable by business application 110 (and by one or other business applications of business system 100) to transmit data to and receive data from social networks 150 and 160. According to the illustrated architecture, each of social network plug-ins 122 is associated with a respective social network and is usable by social network connector 120 to support communication with its respective social network. Consequently, business application 110 uses a same API of social network connector 120 to communicate with any social network associated with one of social network plug-ins 122, regardless of differences between the social networks.

Channel configurations 124 include information needed to communicate with specific social networks. For example, for a given social network, channel configurations 124 may specify an Internet Protocol (IP) address, authentication credentials of business application 110, a social network type, etc.

Each of electronic social networks 150 and 160 provides a respective social network API for low-level communication with external computing systems such as business system 100. According to some embodiments, a social network API allows an external system to create a user within the social network, and to store information in the social network in association with a user of the social network. In some embodiments, the social network API allows an external system to receive requests for user associations from the social network, to accept or deny requests for user associations received from the social network, and to transmit requests for user associations to the social network.

Each of electronic social networks 150 and 160 defines a plurality of users and associations between the plurality of users. The associations define data sharing relationships between the users. Each of electronic social networks 150 and 160 therefore also stores user data associated with each of the plurality of users. The user data may include text, pictures, messages, audio, video, etc.

Either of electronic social networks 150 and 160 may comprise a Web server. The Web server may provide Web pages through which a user may log in to the social network, create users within the social network, and store data in the social network in association with a user of the social network. Such Web pages may also allow a user to view user data of other users with whom the user is associated, to view requests for user associations, to accept or deny requests for user associations, and to create requests for user associations.

Either of electronic social networks 150 and 160 may provide other channels for inbound and/or outbound communication, including but not limited to Short Message Service messages and electronic mail messages.

Examples of electronic social networks 150 and 160 according to some embodiments include Facebook, Twitter, LinkedIn and MySpace. Each of these networks allows a person to create (or register) a user therein and to associate information with the user. This information may be viewed by others according to the rules of the particular social network. The following descriptions are intended to provide a general idea of the above-mentioned electronic social networks and do not attempt to describe all features and options thereof.

Typically, a Facebook user specifies that information associated with the user can be accessed only by other Facebook users with whom the user is associated (i.e., Friends). These associations may be established by sending requests (manually or via an automated process) to the other Facebook users and receiving acceptances of the requests from the other Facebook users. The associations may be more granular and complex than described (e.g., certain Friends may be provided with more access than others, partial access may be provided to non-Friend users) and access to the information may proceed via communication channels specified by either Friend within an association (e.g., electronic mail messages, Web page updates, text messages).

Twitter allows a user to unilaterally create a “Follower” association with another user. Thereafter, information (i.e., tweets) posted by the “followed” user are transmitted to the Follower user via a specified communication channel. In contrast to Facebook, Twitter allows a Follower to consume most information posted by a followed user without being accepted by the followed user.

Some embodiments operate in conjunction with any one or more electronic social networks that are or become known. These one or more social networks may comprise any combination of the foregoing features or any other features that are or become known.

Client devices 130 and 140 are capable of communicating with social networks 150 and 160 as described above, and also with business system 100. For example, either of client devices 130 and 140 may access a user interface provided by business system 100 to access information generated by business application 110. Client devices 130 and 140 are illustrated as a desktop computer and a smartphone/personal digital assistant, respectively, but are not limited thereto. Client devices 130 and 140 may comprise any suitable device(s), such as a laptop computer, a personal digital assistant, and a tablet PC. Client devices 130 and 140 may execute a proprietary application for accessing business system 100 or may execute a Web browser to access business system 100 through a Web-based portal.

FIG. 1 is intended to provide an example of some embodiments. Any of the components of FIG. 1 may operate differently than described and/or may be implemented differently than illustrated. Moreover, the components of FIG. 1 include other unshown elements that may be used during operation thereof, such as any suitable program code, scripts, or other functional data that is executable to interface with other elements, other applications, other data files, operating system files, and device drivers. These elements are known to those in the art, and are therefore not described in detail herein.

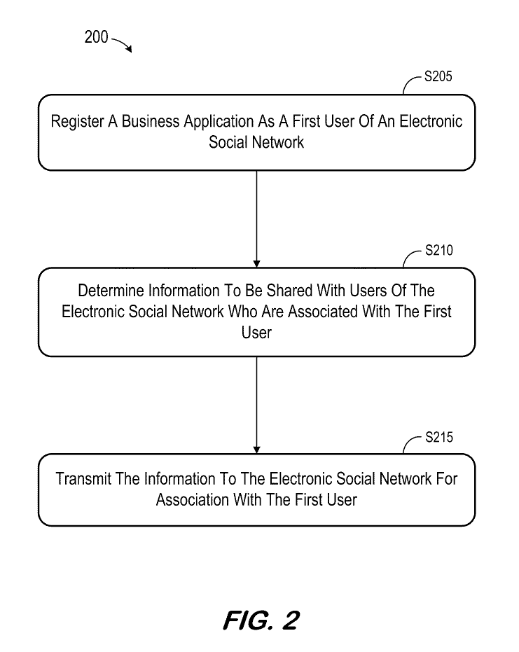

FIG. 2 is a flow diagram of process 200 according to some embodiments. Briefly, process 200 provides registration of a business application as a user of an electronic social network. Process 200 may be performed by business system 100 of FIG. 1, but embodiments are not limited thereto.

Process 200 and all other processes mentioned herein may be embodied in processor-executable program code read from one or more of a tangible computer-readable medium, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S205, a business application is registered as a first user of an electronic social network. For example, business application 110 of FIG. 1 may call an API provided by social network connector 120 to register business application 110 as a user of social network 150. The call may include credentials (e.g., user name and password) to be used during registration of the first user in social network 150.

In response, social network connector 120 identifies one of social network plug-ins 122 corresponding to social network 150 and uses the identified social network plug-in 122 to make appropriate calls to the social network API of social network 150. Social network connector 120 may also use information of channel configurations 124 to locate and communicate with social network 150. The calls result in creation of a first user corresponding to business application 110 within social network 150. Channel configurations 124 may then store information needed for future communication with social network 150 (e.g., IP address, authentication credentials, network type).

Next, at S210, information to be shared with users of the social network is determined. Per typical social network protocols, the users with whom the information is to be shared are those users who are associated with the first user within the social network. The information to be shared may be determined at S210 according to any suitable system. Generally, the information may comprise any data deemed to be of interest to the associated users. If the associated users are members of a sales team, the determined information may include newly-added sales leads.

In some embodiments, notifications 111 specify messages to be shared with associated social network users under particular conditions. For example, S210 may comprise determining that certain conditions have occurred and, based on notifications 111, determining a message (i.e., information) to be shared with associated social network users.

The information is transmitted to the electronic social network at S215. Continuing with the present example, business application 110 may call the API of social network connector 120 to store the information in social network 150 in association with the first user. Social network connector 120 may then call the social network API of social network 150 using a corresponding social network plug-in 122 and corresponding information of channel configurations 134.

As a result of process 200, electronic social network 150 includes a first user corresponding to business application 110 and information associated with the first user.

As described above, user information 112 may associate a business user with user names of one or more electronic social networks. These associations (or mappings) may be established in any suitable manner. In some embodiments, a business application user provides information directly to a business system to associate himself or herself with a social network user. In a particular example, a business application user operates client device 140 to access a Web portal of business system 100, and submits appropriate credentials via a logon page in order to logon to business system 100 as the business application user. Business system 100 evaluates the credentials using authentication data 114 as is known in the art.

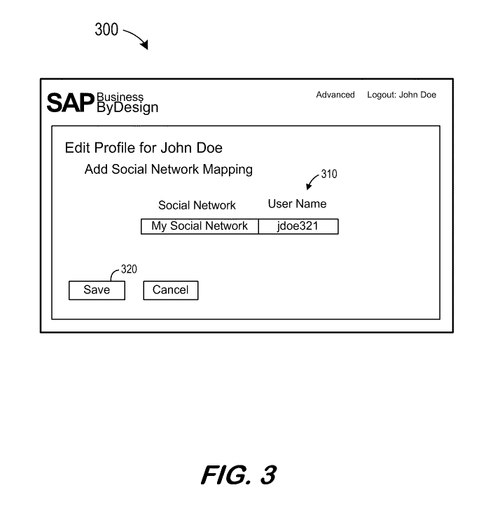

FIG. 3 is an outward view of an interface of business system 100 which may be presented at according to some embodiments. Interface 300 provides input boxes 310 to allow the business application user (i.e., “John Doe”) to specify a user name and a social network. The user name represents the identity of the business application user within the social network. Upon selection of Save icon 320, an association between the business application user and the user name/social network is created.

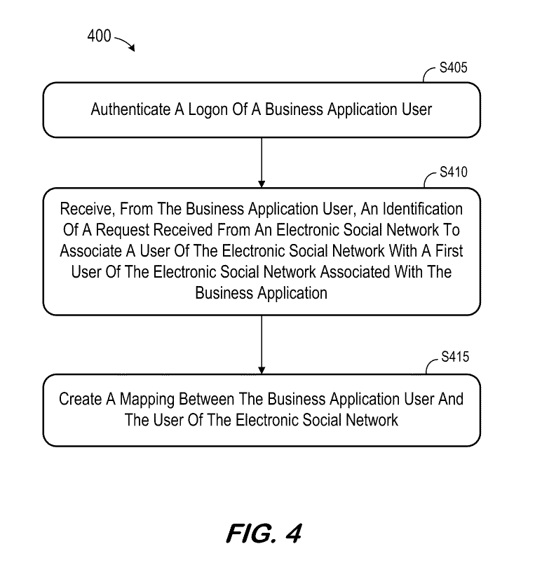

Business systems may implement additional and/or alternative processes for creating associations between business application users and user names/social networks. FIG. 4 is a flow diagram of process 400 for creating an association between a business application user and a user name/social network according to some embodiments.

Initially, at S405, a business application user operates client device 140 to access a Web portal of business system 100, and submits appropriate credentials via a logon page in order to logon to business system 100 as the business application user. Business system 100 evaluates the credentials using authentication data 114 as is known in the art.

A request from an electronic social network is received at a business application at S410. The request is a request to associate a user of the electronic social network with a first user of the electronic social network. As described with respect to process 200, the first user is associated with the business application.

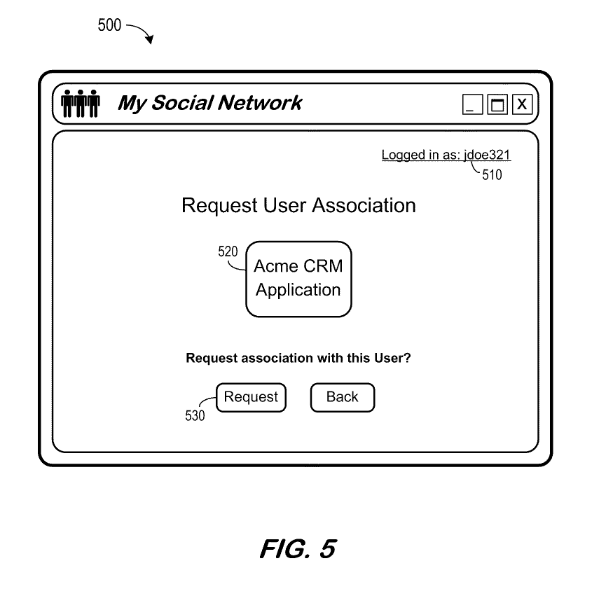

The user of the electronic social network may originate the request prior to S410. According to some examples, the user operates client device 130 to log in to electronic social network 150 and navigate Web pages provided thereby. FIG. 5 is an outward view of a portion of a Web page displayed by client device 130 prior to S410. Web page 500 shows user name 510 of the user and icon 520 representing the aforementioned first user. Web page 500 further includes icon 530 for initiating the request received at S410. Accordingly, it is assumed that the user has selected icon 530 of Web page 500 prior to S410.

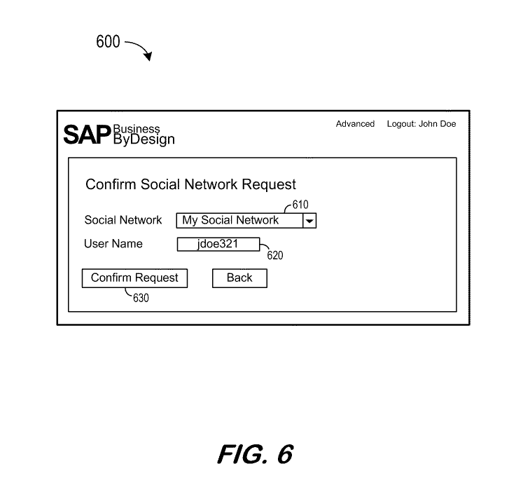

A mapping between the business application user and the user of the social network is then created at S415. FIG. 6 is an outward view of interface 600 of business system 100 which may be presented at S415 according to some embodiments. The business user may operate pull-down menu 610 to specify an electronic social network from which the request was received at S410 and input field 620 to specify a user of the electronic social network who initiated the request. In some embodiments, interface 600 displays the electronic social network and user name of each received and not-yet-confirmed request, and the business application user simply selects the request which corresponds to the business application user.

The business application user selects icon 630 to confirm the request. This confirmation includes creation of a mapping (e.g., in user information 112) between the business application user and the user of the electronic social network.

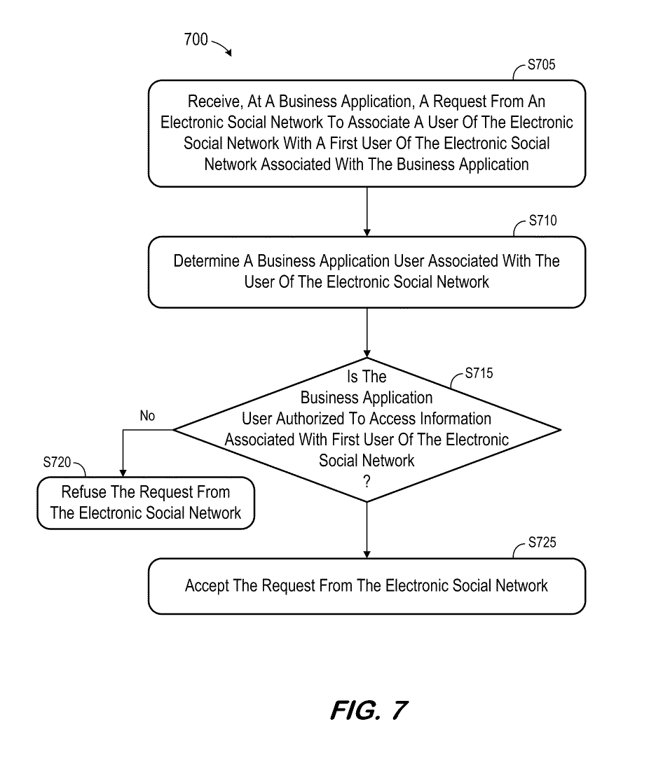

The above-described mapping between a business application user and a user of a social network may be leveraged in several different manners according to some embodiments. For example, process 700 of FIG. 7 may be executed to automatically accept association requests received from an electronic social network.

In particular, a request from an electronic social network is received at a business application at S705. The request is a request to associate a user of the electronic social network with a first user of the electronic social network. Again, the first user is associated with the business application.

Next, at S710, a business application (e.g., business application 110) determines a business application user who is associated with the user of the social network named in the request. In a particular example, business application 110 extracts user identification (i.e., jdoe321) from the request and accesses user information 112 to determine a business application user (“John Doe”) of business system 100 who is associated with the user identification. In this regard, user information 112 may associate user names of business system 100 with user names of one or more electronic social networks to which the users belong.

Next, at S715, it is determined whether the determined business application user is authorized to access information associated with the first user of the electronic social network. This authorization check may proceed according to any authorization mechanism provided by business system 100. For example, the information associated with the first user of the electronic social network may be assigned to particular user roles. Accordingly, S715 may comprise determining whether a user role of the determined business application user is one of the particular user roles assigned to the information. If not, the request is refused at S720. Refusal of the request at S320 may utilize the API of social network connector 120, a social network plug-in 122, channel configurations 124 and the social network API of electronic social network 150 as described above.

If it is determined that the business application user is authorized to access information associated with the first user of the electronic social network, the business application communicates with the electronic social network at S725 to accept the request. For example, business application 110 calls the API of social network connector 120, which in turn uses a social network plug-in 122 and channel configurations 124 to call the social network API of electronic social network 150 to accept the request.

Once the request is accepted, the user of the electronic social network (who is also the determined business application user) may access information associated with the first user (i.e., business application 110) through the electronic social network. The manner of such access depends on the electronic social network. For example, the person may log on to the electronic social network directly (using credentials of the user of electronic social network) to access the information. Additionally or alternatively, the information may be pushed via a default communication channel (e.g., electronic mail).

Some embodiments therefore facilitate consumption and/or distribution of business information generated by business applications. A user may, for example, log on to a social network to consume personal information as well as business information, reducing a need to separately log on to a business system. Moreover, consumption of business information over social networks may be better available, e.g. to mobile devices and laptops logged on to public networks, than access to backend systems using native clients, which is typically restricted to the limits of the company network.

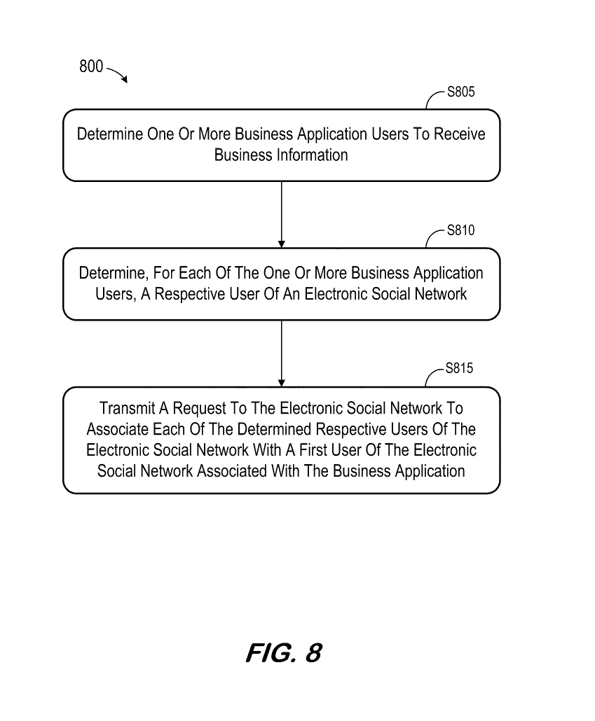

FIG. 8 is a flow diagram of process 800 to originate electronic social network requests according to some embodiments. S805 includes determining one or more business application users to receive business information.

According to the example of FIG. 1, business application 110 may determine that particular business application users would be interested in particular business information to be transmitted to an electronic social network. For example, business application 110 may determine that business application users associated with the “sales” role should receive business information associated with new sales leads. Accordingly, S805 comprises determining one or more business application users associated with the “sales” role. S805 may also or alternatively comprise determining all business application users who are authorized to access the particular business information.

Next, at S810, a respective user of an electronic social network is determined for each of the determined one or more business application users. As described above, user information 112 may associate users of business system 100 with user names of one or more electronic social networks to which the users belong. The determination at S810 may therefore be based on user information 112.

A request is transmitted to the electronic social network at S815. The request is a request for association of each of the users determined at S810 with a first user of the electronic social network. As described with respect to process 200 and 300, the first user is associated with the business application. The requests may be transmitted by business application 110 via social network connector 120 as detailed above.

The request does not necessarily create any associations within the electronic social network. Rather, each of the determined users receives a respective request to become associated with the first user (i.e. business application 110). The request may be received and accepted in any suitable manner, depending on the particular electronic social network. Upon accepting the request, a determined user may access business information associated with the first user in the manners prescribed by the particular electronic social network.

FIG. 8 is an outward view of interface 900 for presenting a received request to a user of an electronic social network according to some embodiments. Interface 900 indicates a user 910 determined at S810 of process 800, and displays icon 920 indicating the first user with whom an association is being requested. The user of the electronic social network may accept the request by selecting icon 930 and may refuse the request by selecting icon 940. If the request is accepted, an association between the first user and the user of the electronic social network is created in the electronic social network.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize that other embodiments may be practiced with modifications and alterations limited only by the claims.

What is claimed is:

1. A computer-implemented method comprising:
registering a business application as a first user of an electronic social network comprising a plurality of users, data associated with each of the plurality of users, and associations between users representing data sharing relationships between associated users;
determining information to be shared with users of the electronic social network who are associated with the first user; and
transmitting the information to the electronic social network for association with the first user.

2. A computer-implemented method according to claim 1, further comprising:
receiving a request from the electronic social network to associate a second user of the electronic social network with the first user of the electronic social network;
determining a correspondence between the second user of the electronic social network and a user of the business application;
determining whether the user of the business application is authorized to access the information to be shared with users of the electronic social network who are associated with the first user; and
if it is determined that the user of the business application is authorized to access the information, accepting the request from the electronic social network.

3. A computer-implemented method according to claim 1, further comprising:
determining one or more business application users to receive the information;
determining a user of the electronic social network corresponding to each one of the one or more business application users; and
transmitting a request to the electronic social network to associate each of the determined users with the first user of the electronic social network.

4. A computer-implemented method according to claim 1, further comprising:
registering the business application as a second user of a second electronic social network; and
transmitting the information to the second electronic social network for association with the second user.

5. A system comprising:
a social network connector to communicate with an electronic social network comprising a plurality of users, data associated with each of the plurality of users, and associations between users representing data sharing relationships between associated users; and
a business application to:
use the social network connector to register as a first user of the electronic social network;
determine information to be shared with users of the electronic social network who are associated with the first user; and
use the social network connector to transmit the information to the electronic social network for association with the first user.

6. A system according to claim 5, the business application further to:
receive a request from the electronic social network to associate a second user of the electronic social network with the first user of the electronic social network;
determine a correspondence between the second user of the electronic social network and a user of the business application;
determine whether the user of the business application is authorized to access the information to be shared with users of the electronic social network who are associated with the first user; and
if it is determined that the user of the business application is authorized to access the information, accept the request from the electronic social network.

7. A system according to claim 5, the business application further to:
determine one or more business application users to receive the information;
determine a user of the electronic social network corresponding to each one of the one or more business application users; and
use the social network connector to transmit a request to the electronic social network to associate each of the determined users with the first user of the electronic social network.

8. A system according to claim 5, the business application further to:
use the social network connector to register the business application as a second user of a second electronic social network; and
use the social network connector to transmit the information to the second electronic social network for association with the second user.

9. A system according to claim 5, further comprising the electronic social network.

10. A computer-readable medium storing program code executable by a computer to:
register as a first user of an electronic social network comprising a plurality of users, data associated with each of the plurality of users, and associations between users representing data sharing relationships between associated users;
determine information to be shared with users of the electronic social network who are associated with the first user; and
transmit the information to the electronic social network for association with the first user.

11. A medium according to claim 10, the program code further executable by a computer to:
receive a request from the electronic social network to associate a second user of the electronic social network with the first user of the electronic social network;
determine a correspondence between the second user of the electronic social network and a user of the business application;
determine whether the user of the business application is authorized to access the information to be shared with users of the electronic social network who are associated with the first user; and
if it is determined that the user of the business application is authorized to access the information, accept the request from the electronic social network.

12. A medium according to claim 10, the program code further executable by a computer to:
receive a request from the electronic social network to associate a second user of the electronic social network with the first user of the electronic social network;
determine a correspondence between the second user of the electronic social network and a user of the business application;
determine whether the user of the business application is authorized to access the information to be shared with users of the electronic social network who are associated with the first user; and
if it is determined that the user of the business application is authorized to access the information, accept the request from the electronic social network.

13. A medium according to claim 10, the program code further executable by a computer to:
determine one or more business application users to receive the information;
determine a user of the electronic social network corresponding to each one of the one or more business application users; and
transmit a request to the electronic social network to associate each of the determined users with the first user of the electronic social network.

14. A medium according to claim 10, the program code further executable by a computer to:
register the business application as a second user of a second electronic social network; and
transmit the information to the second electronic social network for association with the second user.
